(19) United States
(12) Patent Application Publication
(10) Pub. No.: US 2008/0175622 A1
(43) Pub. Date: Jul. 24, 2008

(54) IMAGE FORMING APPARATUS AND IMAGE FORMING METHOD

(75) Inventors: Yusuke Hashizume, Urayasu-shi (JP); Kunihiko Miura, Hiratsuka-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/626,494

(22) Filed: Jan. 24, 2007

(51) Int. Cl. G03G 15/00

(52) U.S. Cl. 399/208

(57) ABSTRACT

An image forming apparatus in the present invention includes an automatic document feeder (ADF) for carrying an original document, a scanner unit and a printer unit, the scanner unit includes a carriage having a light source unit for exposing and scanning the original document and is capable of operating in a first reading mode (sheet-through system) for reading image information of the original document carried by the ADF with the carriage fixed and a second reading mode (platen system) for reading the image information of the original document by moving the carriage. When reading the original document, the scanning velocity is controlled, the reading resolution of the original document in the first reading mode is set to be lower than the resolution of image formation by the printer unit, and the reading resolution of the original document in the second reading mode is controlled to be substantially equal to the resolution of image formation by the printer unit. There is provided an image processing unit for performing image conversion for the image information read by the scanner unit according to the reading magnification.

### BACKGROUND OF THE INVENTION

1. Field of the Invention

The present invention relates to an image forming apparatus such as MFP (Multi-Function Peripherals) and copying machines, which are digital multi-function machines and an image forming method.

2. Description of the Related Art

In the related art, an image forming apparatus such as MFP includes a scanner unit and a printer unit, and is configured to read original documents by the scanner unit, process image data read in the scanner unit by an image processing unit, and print the same by the printer unit.

The image forming apparatus includes an automatic document feeder (ADF), and the scanner unit reads the original document fed by the ADF, or reads the original document placed on a document table. In general, when copying a large amount of original documents, the scanner unit reads the original documents fed by the ADF in sequence, and when copying images of pictures or books, the original documents is placed on the document table and read one by one.

In general, a system to read the original document fed by the ADF is referred to as a sheet-through system, and a system to read the original document placed on the document table is referred to as a platen system. When reading the original document through the sheet-through system and the platen system in the related art, the original document is read at the same resolution without changing the reading resolution, is processed by the image processing unit, and is printed by the printing unit.

However, when the document is read by the sheet-through system and the platen system, there are following disadvantages since the reading resolution is the same. That is, when the reading resolution is set to a high value, it is necessary to set the velocity to carry the original documents by the ADF at a low value. Therefore, the processing time required for printing one sheet is increased, and hence the productivity is lowered. Also, when the velocity for carrying the original document is increased for improving the productivity, the resolution is lowered.

In Japanese Patent Document, JP-A-2001-22138, there is a description relating an automatic document feeder (ADF). In this example, the reading mode can be set to two different modes for a case of attaching importance to the productivity in which the original documents carried by the ADF in sequence is read at a low resolution, and a case of attaching importance to the image quality in which the original documents placed on the document table one by one is read at a high resolution.

However, in this example, the relationship between the resolution of the printer unit and the reading resolution of the scanner unit is not described. A process to be executed when the reading magnification is different is not described.

The present invention provides an image forming apparatus in which the productivity and the printing quality are improved.

### DESCRIPTION OF THE DRAWINGS

FIG. 1 illustrates a general configuration of an image forming apparatus according to an embodiment of the invention;

FIG. 2 is a block diagram showing a configuration of an embodiment of the image forming apparatus according to the invention;

FIG. 3 is a block diagram showing a circuit relating to an original document reading and printing process in the image forming apparatus according to the invention;

FIG. 4A and FIG. 4B are explanatory drawings for explaining operation of a scanner unit in the image forming apparatus according to the invention;

FIG. 5 is an explanatory drawing showing the relationship between the reading resolution and the scanning velocity of the scanner unit in the image forming apparatus according to the invention;

FIG. 6 is a flowchart for explaining an original document reading operation in the image forming apparatus according to the invention;

FIG. 7 is a flowchart for explaining an operation of an image conversion process in the image forming apparatus according to the invention;

FIG. 8 is a flowchart for explaining according to another embodiment of the image conversion process in the image forming apparatus according to the invention.

### DETAILED DESCRIPTION OF THE INVENTION

Throughout this description, the embodiments and examples shown should be considered as exemplars, rather than limitations on the apparatus and methods of the present invention.

Referring now to the drawings, embodiments of the invention will be described in detail.

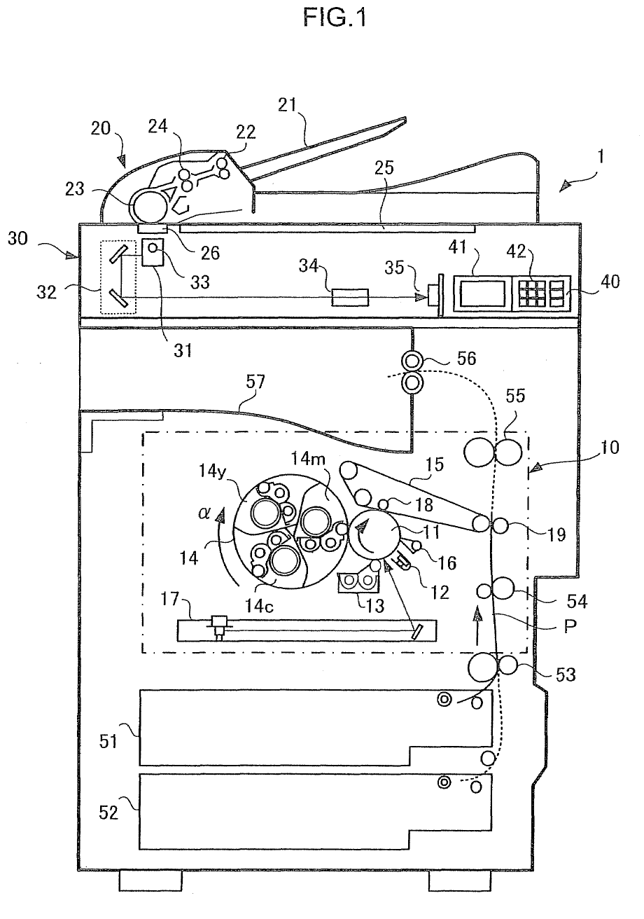

FIG. 1 is a drawing schematically showing an entire configuration of an image forming apparatus according to an embodiment of the invention. In FIG. 1, MFP (Multi-Function Peripherals) will be described as an example of the image forming apparatus. However, it may also be applied to a copying machine and so on.

In FIG. 1, reference numeral 1 designates an image forming apparatus, and a printer unit 10 is provided at the center of the image forming apparatus 1. The printer unit 10 includes a photoconductive drum 11. In the periphery of the photoconductive drum 11, a charging device 12, a monochrome developing device 13 for developing an electrostatic image formed on the photoconductive drum 11, and a developing device 14 for developing a color electrostatic image.

Arranged in the periphery of the photoconductive drum 11 is an intermediate transfer belt 15 and cleaning and diselectrifying device 16. Arranged also in the periphery of the photoconductive drum 11 is an exposure device 17 for causing the photoconductive drum 11 to be irradiated with a laser beam. The intensity of the laser beam is modulated according to image information to be printed.

The developing device 14 is a revolver type having developing units 14y, 14c, 14m for Y (yellow), C (cyan), and M (magenta). The developing units 14y, 14c, 14m each include a developing machine and a toner cartridge.

The developing units 14y, 14c, 14m for Y, C, M of the developing device 14 are arranged so as to be capable of rotating in the direction indicated by an arrow a about a center axis thereof, and is rotated to a developing position which opposes the photoconductive drum 11 in sequence according to a command of image output. When the image to be printed is a color image, image data for each color component formed on the photoconductive drum 11 are developed by the developing units 14y, 14c, 14m for Y, C, M and transferred on the transfer belt 15 and superimposed in sequence.

Provided inside the intermediate transfer belt 15 is an intermediate transfer device 18 for transferring a toner image developed on the photoconductive drum 11 to the intermediate transfer belt 15. A transfer device 19 for transferring the toner image transferred on the intermediate transfer belt 15 on a paper sheet P is provided in a carrier path for the paper sheet P.

An ADF 20 (Automatic Document Feeder 20) is provided at the top of the image forming apparatus 1. The ADF 20 includes a tray 21, feed rollers 22, a carrier roller 23, and intermediate rollers 24, and the ADF 20 is provided so as to oppose the document table 25 and is openable and closable.

The sheet-type original documents set in the tray 21 are retracted one by one by the rotation of the feed rollers 22, and are carried by the intermediate rollers 24 and the carrier roller 23. Provided at a position adjacent to the document table 25 and opposed to the carrier roller 23 is a reading window 26.

A scanner unit 30 is provided under the document table 25 of the image forming apparatus 1. The scanner unit 30 is configured to read the original document carried by the ADF 20 and the original document placed on the document table 25, and has a first carriage 31 and a second carriage 32. The first carriage 31 includes a light source unit 33 which exposes and scans the original document, and the second carriage 32 reflects light reflected from the original document and guides the reflected light to a light receiving unit 35 via a lens 34.

The light receiving unit 35 has an image sensor such as CCD. The reflected light from the original document is converted into an electric current according to the intensity of the light by the CCD sensor, then is A/D converted, is threshold-controlled at a predetermined level, and is converted into a voltage. Then, the image processing is applied to generate image data.

When the scanner unit 30 reads the original document carried by the ADF 20, the first carriage 31 is fixed at the position of the reading window 26 and the second carriage 32 is also at a fixed position. When reading the original document placed on the document table 25, the first carriage 31 and the second carriage 32 are moved in parallel with the document table 25 within a predetermined range. Detail description will be given later.

An operation panel 40 is provided on the upper portion of the image forming apparatus 1. The operation panel 40 includes a display unit 41 and an operation unit 42. Paper feed cassettes 51, 52 are provided in a plurality of levels in the lower portion of the image forming apparatus 1, and the paper sheets P in the paper feed cassettes 51, 52 are carried upward by carrier rollers 53, resist rollers 54, and fixing rollers 55 and are discharged by paper discharge rollers 56 to a paper discharge tray 57.

When forming the image, a laser beam is outputted from the exposure device 17 on the basis of information read by the light receiving unit 35. The surface of the photoconductive drum 11 is irradiated with the laser beam. Accordingly, a latent image according to the intensity of the laser beam is formed on the photoconductive drum 11.

The latent image formed on the photoconductive drum 11 is visualized as a toner image by toner in a corresponding color selectively supplied from the monochrome developing device 13 or the color developing device 14. The toner image on the photoconductive drum 11 is carried to an intermediate transfer position by the rotation of the photoconductive drum 11 and is transferred to the transfer belt 15 by an intermediate transfer voltage provided from the intermediate transfer device 18.

The toner image transferred to the transfer belt 15 is carried to a transfer area opposing a transfer device 19 by the movement of the transfer belt 15, and is transferred to the paper sheet P supplied at a predetermined timing. A transfer bias voltage is supplied from the transfer device 9.

The paper sheet P, on which the toner image is transferred, is guided to the fixing device 55, and the toner image is fixed to the paper sheet P by heat supplied from the fixing device 55. The paper sheets, on which the images are fixed by the fixing device 55, are carried by the paper discharge tray 57 by the rollers 56 in sequence. The configuration of the printer unit 10 is not limited to the example shown in the drawing, and various configurations exist.

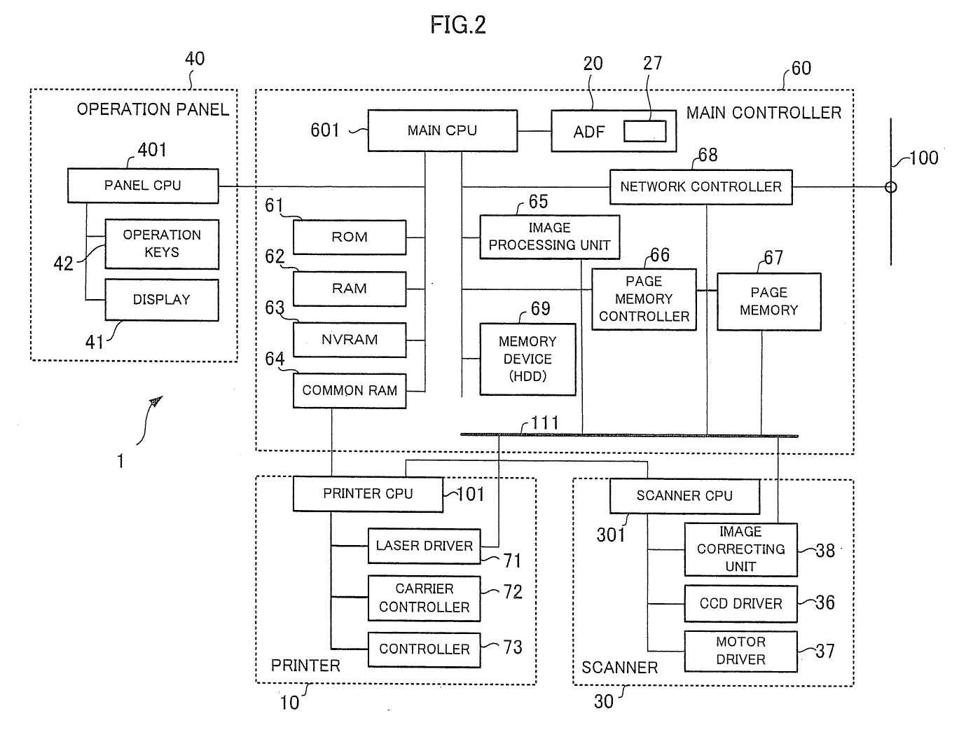

FIG. 2 is a block diagram showing a configuration of the image forming apparatus (MFP) 1 in the invention.

In FIG. 2, the MFP 1 includes a main controller 60, the operation panel 40, the scanner unit 30 and the printer unit 10. A control system of the MFP 1 includes a plurality of CPUs, such as a main CPU 601 in the main controller 60, a panel CPU 401 of an operating unit 4, a scanner unit CPU 301 of the scanner unit 30, and a printer unit CPU 101 of the printer unit 10.

The main controller 60 includes the main CPU 601, a ROM (Read Only Memory) 61, a RAM 62, a NVRAM 63, a common RAM 64, an image processing unit 65, a page memory controller 66, a page memory 67, a network controller 68, and an HDD 69 as a storage device. Reference numeral 111 designates an image data bus.

The main CPU 601 is configured to control the entire operation of the MFP 1, and also to control the ADF 20. The ROM 61 includes a control program stored therein. The RAM 62 is configured to store data temporarily, and the NVRAM 63 is a non-volatile memory, so that the stored data is maintained even when a power source is turned off. The common RAM 64 is used for achieving communication between the main CPU 601 and the printer unit CPU 101 in both-directions.

The image processing unit 65 controls storing and reading of image data to the page memory 67 by controlling the page memory controller 66. Accordingly, an image conversion process such as enlargement or contraction of the image information is performed. The page memory 67 has an area in which image information for a plurality of pages can be stored, and is capable of storing the image information from the scanner unit 30 for each page.

The network controller 68 is connected to a network 100, and the MFP 1 is connectable to an external equipment, such as a server or a PC (Personal Computer) via the network controller 68.

The HDD 69 is configured to compress the image data read by the scanner unit 30 or the image data from the PC (document data, drawn image data, etc.) and store the same therein. The image data stored in the HDD 69 is processed in the image processing unit 65 and is applied with various types of image processing, and is printed on the paper sheet by the printer unit 10.

The operation panel 40 includes the panel CPU 401 connected to the main CPU 601, the display 41 composed of liquid crystal or the like, and various operation keys 42. The operation keys 42 are used for entering various instructions such as the number of printing copies, the paper size, the printing magnification, while the display 41 is configured to achieve various displays and has a touch-panel function.

The scanner unit 30 includes the scanner CPU 301 for controlling the operation of the scanner unit 30, a CCD driver 36 for driving an image sensor, a motor driver 37, and an image correcting unit 38.

The CCD driver 36 reads an image of the original document by driving the image sensor, and coverts it into image data. The first and second carriages 31, 32 are controlled to move by a scan motor (not shown), and the scan motor is controlled by the motor driver 37.

The image correcting unit 38 includes an A/D conversion circuit for converting analogue signals of R, G and B outputted form the image sensor into digital signals respectively, a shading correction circuit and a line memory for storing corrected digital signals from the shading correction circuit temporarily.

The printer unit 10 includes the printer unit CPU 101 for controlling the operation of the printer unit 10, a laser driver 71 for driving the laser of the exposure device 17, a carrier controller 72 for controlling carrying of the paper sheets P, and a controller 73 for controlling a charger, a developing machine, and a transfer unit.

The main CPU 601 communicates with the printer unit CPU 101 in both-directions via the common RAM (Random Access Memory) 64. The main CPU 601 issues an operation instruction and the printer unit CPU 101 returns a status. The printer unit CPU 101 and the scanner unit CPU 301 communicate with each other in serial. The printer unit CPU 101 issues an operation instruction, and the scanner unit CPU 301 returns a state.

The image processing unit 65, the page memory 66, the network controller 68, the image correcting unit 38, and the laser driver 71 are connected by the image data bus 111. The main CPU 601 controls the ADF 20. The ADF 20 includes a carrier motor (not shown) for rotating the carrier roller 23 or the like and the carrier motor is controlled by a carrier motor driver 27.

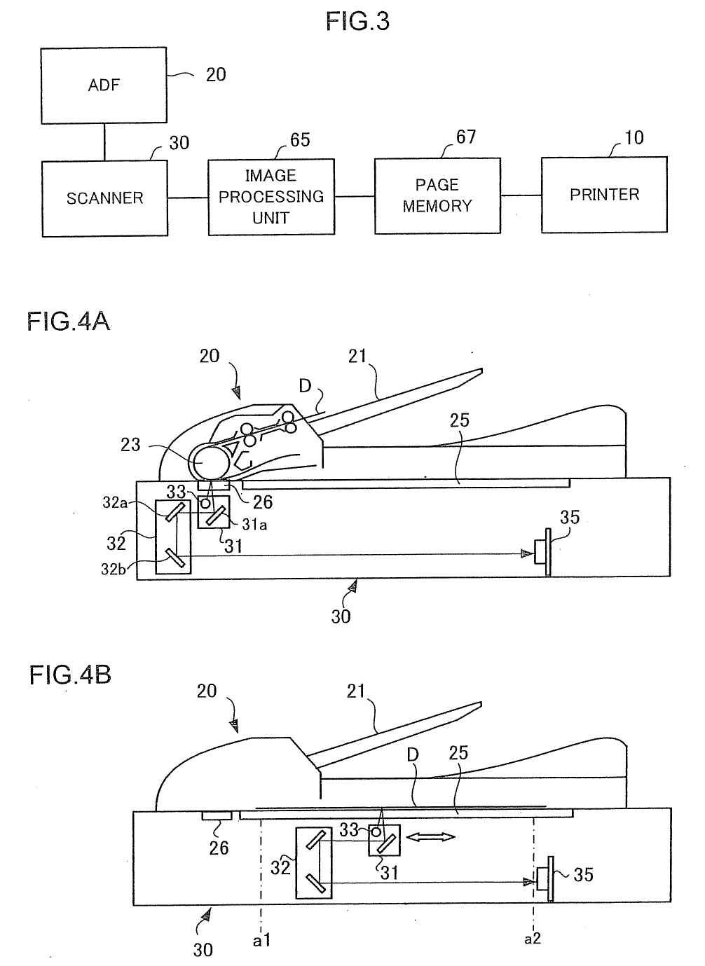

A principal circuit used in a process from reading of the original document by the scanner unit 30 until printing of the same by the printer unit may be shown in a block diagram in FIG. 3. FIG. 3 includes the ADF 20, the scanner unit 30, the image processing unit 65 for applying a conversion process to the image, the page memory 67 and the printer unit 10.

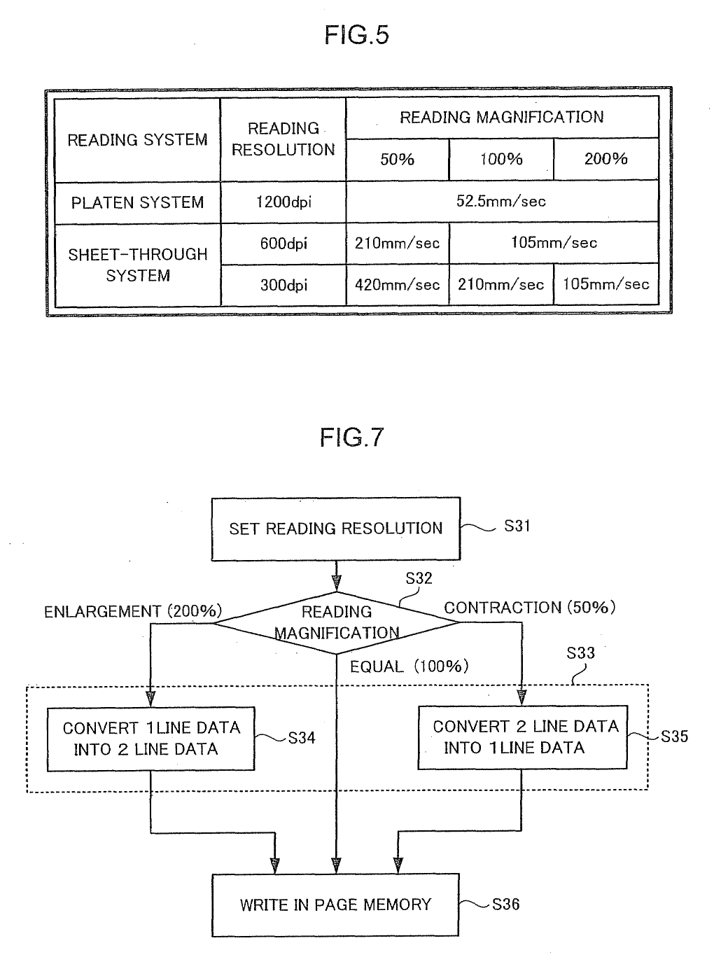

Referring now to FIG. 4A and FIG. 4B, an operation to read the original document by the scanner unit 30 will be described.

FIG. 4A shows a first reading mode (sheet-through system) that reads an image on an original document D carried by the ADF 20, and FIG. 4B shows a second reading mode (platen system) that reads the image on the original document D placed on the document table 25.

In the case of the sheet-through system, as shown in FIG. 4A, in the scanner unit 30, the first carriage 31 is fixed at the position of the reading window 26 (proximal portion), and the second carriage 32 is at a position close to the first carriage 31. The original document D is carried at a predetermined velocity by the carrier motor driver 27 for driving the carrier roller 23.

The original document D carried from the ADF 20 is irradiated with light from the light source unit 33 of the first carriage 31 through the reading window 26. The first carriage 31 is provided with a reflection mirror 31a for reflecting light reflected from the original document D toward the second carriage 32.

The light reflected from the reflection mirror 32a is reflected from reflection mirrors 32a, 32b of the second carriage 32, and is guided to the light detection unit 35 via the lens 34 (see FIG. 1). The light detection unit 35 generates image data using the image sensor.

In the case of the platen system, as shown in FIG. 4B, the scanner unit 30 moves the first carriage 31 and the second carriage 32 in parallel with the document table 25 and reads the original document placed on the document table 25. The first carriage 31 and the second carriage 32 move at a predetermined velocity by the scan motor driver 37 that drives the scan motor.

In this case, it is necessary to equalize the length of an optical path from a reading point of the original document D to the light detection unit 35. Therefore, the velocities of movement of the first carriage 31 and the second carriage 32 are set to in such a manner that the velocity of movement of the second carriage 32 is set to be V/2 when the velocity of movement of the first carriage 31 is V. Therefore, while the first carriage 31 moves by a distance from a proximal portion a1 to a terminal portion a2, the second carriage 32 moves by half a distance of the first carriage 31.

In the case of the platen system, the velocity of movement of the first carriage 31 (the second carriage 32) is set to be constant, so that the resolution at the time of reading is increased. On the other hand, when the sheet-through system is employed, the velocity to carry the original document D is set to be higher than the velocity of movement of the first carriage 31, the velocity to carry the original document D is variable, and the reading resolution is set to be lower than the case of the platen system.

For example, it is set such that when the resolution at the time of reading in the platen system is set to 1200 dpi, the reading resolution in the sheet-through system is 600 dpi or 300 dpi.

In the case of the sheet-through system, when the reading magnification is different, the velocity to carry the original document is switched according to the magnification, and the resolution is converted to 600 dpi or 300 dpi by the image conversion process. In the case of the platen system as well, when the reading magnification is different, the image conversion process is carried out according to the magnification.

Since the reading resolution is differentiated between the platen system and the sheet-through system, the drive motor for carrying the paper sheets and the drive motor for moving the carriage have naturally different numbers of revolutions.

FIG. 5 is a drawing showing the relationship between the resolutions in the platen system and the sheet-through system, and the scanning velocity when reading the original document D.

In FIG. 5, it is assumed that the resolution of image formation in the printer unit 10 is 1200 dpi. The scanning velocity is determined by the velocity of movement of the first carriage 31 in the platen system, and is determined by the velocity to carry the original document D in the sheet-through system. Therefore, the scanning velocity is determined by the movement of the first carriage 31 and the number of revolution of the drive motor used for carrying the original document D.

The scanning direction means a secondary scanning direction when forming the image on the paper sheet P and, in the case of the sheet-through system, it corresponds to the carrying direction of the original document D, and in the case of the platen system, it corresponds to the direction of movement of the carriage 31.

As will be seen from FIG. 5, the reading resolution of the original document in the platen system is fixed to 1200 dpi, and the scanning velocity is constantly 52.5 mm/sec. When the reading resolution in the platen system is fixed even when the magnification is changed, the inexpensive drive motor may be used. When the reading magnification is varied (50% or 200%), the image conversion process according to the magnification is carried out in the image processing unit 65, and the image data is supplied to the printer unit 10. Accordingly, the output resolution of the printer unit 10 is kept constant, and the high resolution is maintained. The image conversion process will be described later.

Therefore, when reading the original document in the platen system, the image is read at the same resolution as the resolution in the printer unit, and hence reading with an excessive specification is avoided, so that productivity may be improved.

Assuming that the reading resolution in the platen system is 1200 dpi, since the scanning velocity is 52.5 m/sec (constant), the torque required for the drive motor to operate is on the order of 300 mN·m, and hence a small motor may be employed. Generally, the small motor may suffer from uneven revolution. However, since the scanning velocity is fixed, it may be rotated beyond the range of resonance frequency of the motor by increasing the number of revolution, and the influence of the uneven revolution may be avoided.

On the other hand, the reading resolution in the sheet-through system is 600 dpi or 300 dpi, and either one of the resolutions may be selected by users. In the sheet-through system, the scanning velocity is varied with the reading magnification.

In other words, in a case in which the reading resolution is 600 dpi, when the reading magnification is the equal magnification (100%), and when the reading magnification is 200%, the scanning velocity is 105 mm/sec, and when the reading magnification is 50%, the scanning velocity is 210 mm/sec.

In a case in which the reading resolution is 300 dpi, when the reading magnification is the equal magnification (100%), the scanning velocity is 210 mm/sec, when the reading magnification is 50%, the scanning velocity is 420 mm/sec, and when the reading magnification is 200%, the scanning velocity is 105 mm/sec.

However, in the sheet-through system, in the case in which the reading resolution is 600 dpi, improvement of productivity is not much different between the case in which the reading magnification is 200%, and the case in which the reading magnification is 100%. Therefore, there is a possibility that uneven revolution of the motor may be resulted when the scanning velocity is varied. Therefore, there is a probability that degradation of the image quality occurs. Therefore, the velocity to carry the original document is not changed and the output resolution is maintained at 600 dpi by the image conversion process in the image processing unit 65.

In this manner, in the sheet-through system, a great amount of document reading may accommodated by reading the original document at a lower resolution than the reading resolution in the platen system. That is, by increasing the velocity to carry the original document D, the original document is read at a low resolution, and the document can be read at a high velocity. Accordingly, the productivity is improved.

In the sheet-through system, since the original document itself is carried, it is difficult by nature to read at a high resolution due to flapping of the paper sheet or the like. Therefore, by carrying out reading at high productivity, even though the resolution is not the same as that of the printer unit 10, the value as the image forming apparatus is improved.

Since the resolution is increased by the image conversion process corresponding to the variation in the reading magnification, the velocity range of the drive motor which carries the original document D may be restrained to a velocity range on the order of four times. That is, in the scanner unit 30, since it is not necessary to read at a high resolution, the motor which corresponds to a velocity range for the low resolution (that is, high-velocity reading) may be employed, and hence a less expensive image forming apparatus may be provided as a whole.

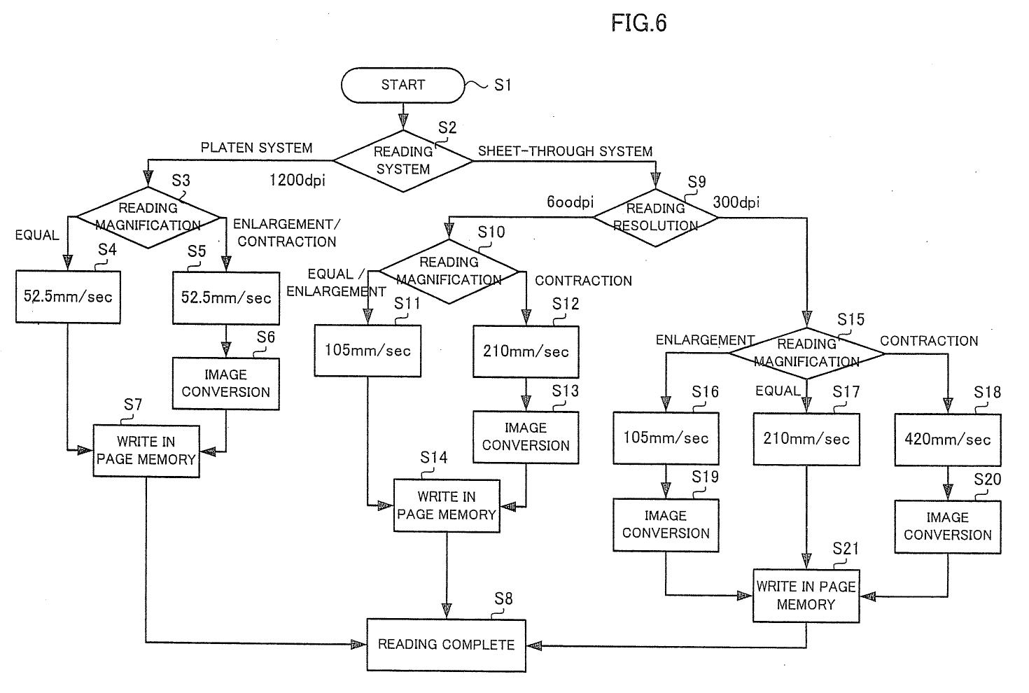

FIG. 6 is a flowchart for explaining the operation of the image forming apparatus according to the invention, focusing on the reading operation in the scanner unit 30 and the operation of the image conversion in the image processing unit 65.

In FIG. 6, in Step S1, reading of the original document D is started. In Step S2, the reading system, that is, whether the platen system or the sheet-through system is employed is determined. In the case of the platen system, an original document is placed on the document table 25, and in the case of the sheet-trough system, the original document is set on the tray 21. Therefore, the system can be determined from the difference of how the document is set.

In the case of the platen system, the procedure goes to Step S3, where the reading magnification of the original document is determined. Since the magnification is set by the user, if it is set to the equal magnification, the velocity of movement of the carriage 31 is set to 52.5 mm/sec to scan the original document D in Step S4.

When the reading magnification is different (enlarged or contracted), the velocity of the carriage 31 is also set to 52.5 mm/sec to scan the original document D in Step S5, and the image conversion process is performed in Step S6. The image conversion process will be described later.

The data read in Step S4 and the data after having applied with the image conversion process in Step S6 are written in the page memory 67 in Step S7, and are read completely in Step S8.

When it is determined that the sheet-through system is employed in Step S2, the procedure goes to Step S9, where the reading resolution is determined. In the sheet-through system, the reading resolution may be selected from between 600 dpi and 300 dpi, and when the mode of 600 dpi is selected by the user, the reading magnification of the original document D is determined in Step S10.

When the equal magnification or enlargement is selected by the user in Step S10, the original document D is carried, for example, at the velocity to carry of 105 mm/sec and is scanned in Step S11. When the reading magnification is contraction, the original document D is scanned at the velocity to carry of 210 mm/sec in Step S12, and then the image conversion process is performed further in Step S13. The image conversion process will be described later.

The data read in Step S11 and the data after having applied with the image conversion process in Step S13 are written in the page memory 67 in Step S14, and are read completely in Step S8.

When the reading resolution of 300 dpi is selected by the user in Step S9, the reading magnification of the original document is determined in Step S15.

When enlargement is selected by the user in Step S15, the original document D is carried and scanned at the velocity to carry of 105 mm/sec in Step S16. When the equal magnification is selected in Step S15, the original document D is carried and scanned at the velocity to carry of 210 mm/sec in Step S17. When contraction is selected in Step S15, the original document D is carried and scanned at the velocity to carry of 420 mm/sec in Step S18.

When the reading magnification is enlargement or contraction, the image conversion process is performed in Steps S19 and S20. The image conversion process will be described later.

The data read in Step S17 and the data having applied with the image conversion process in Steps S19 and S20 are written in the page memory 67 in Step S21, and are read completely in Step S8.

In this manner, in the case of the platen system, the velocity of movement of the carriage 31 is fixed to 52.5 mm/sec to scan at a low-velocity, so that reading at the high resolution is achieved. In the sheet-through system, the reading resolution is set to a low value, and the velocity to carry the original document is switched step-by-step according to the reading resolution to read at the high-velocity, so that productivity is improved.

Subsequently, the image conversion process will be described. In the image conversion process, the process is switched according to the reading magnification of the original document and, basically, the image conversion process is not performed when the reading magnification is the equal magnification (100%), and the read data is written in the page memory 67 as is, and is performed when the reading magnification is enlargement (200%, for example) and contraction (50%, for example).

FIG. 7 is a flowchart of the image conversion process according to the reading magnification. Step S31 is a step of setting the reading resolution, and Step S32 is a step of determination of the reading magnification, and Step S33 is a step of image conversion process. In Step S33, the image conversion for enlargement is performed in Step S34, and the image conversion for contraction is performed in Step S35. However, the image conversion process is not performed for the equal magnification in this step and writing in the page memory 67 is performed in the next step, Step S36, respectively.

When the reading magnification is 200%, data for one line is written in the page memory 67 twice, and when the reading magnification is 50%, the data for two lines is converted into a single line data and is written in the page memory 67. In this manner, the image processing corresponding to the reading magnification (equal, enlargement, and contraction) is achieved.

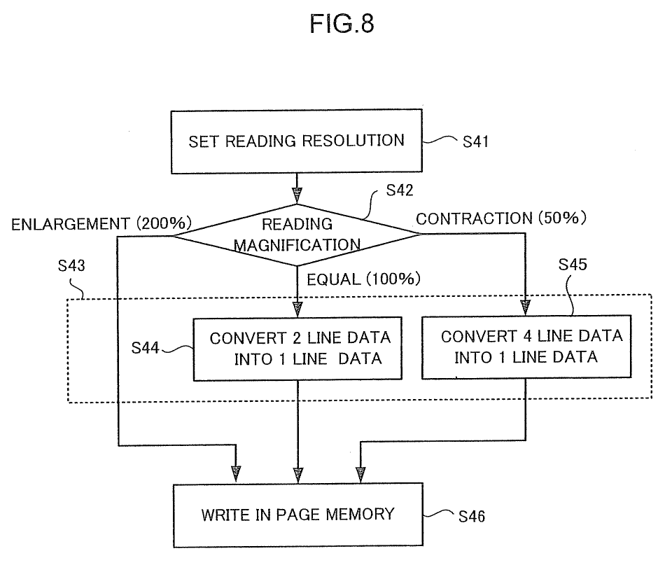

There are several methods for the image conversion process, and a method shown in FIG. 8 is also applicable. In other words, Step S41 is a step of setting the reading resolution, Step S42 is a step of determining the reading magnification, and Step S43 is a step of the image conversion process. In Step S43, the image conversion for the equal magnification is performed in Step S44, the image conversion for contraction is performed in Step S45. However, the image conversion process is not performed for enlargement in this step, and writing in the page memory 67 is performed in the next step, Step S46, respectively.

When the reading magnification is 200%, the data for single line is written in the page memory 67 as is, and when the reading magnification is the equal magnification (100%), the data for two lines is converted into a single line data, and is written in the page memory 67. When the reading magnification is 50%, the data for four lines is converted into a single line data, and is written in the page memory 67. In this process as well, the image processing corresponding to the reading magnification (equal, enlargement, and contraction) is achieved.

In this manner, in the invention, the original document can be read by the platen system or the sheet-through system, and when reading in the platen system, the reading resolution can be set to a high resolution. When reading in the sheet-through system, improvement of productivity is achieved. When the reading magnification is different, a constant output resolution can be achieved in each system by performing the image conversion process.

When the user wants to copy the image at a high resolution, what has to be done is simply to place the original document on the document table 25, and when the user wants to copy a large amount of original documents, what has to be done is simply to set the original documents on the tray 21. Therefore, the user may enjoy copying of high-quality, high-productivity without completed setting.

The numerical values of the scanning velocity or the resolution described in, for example, FIG. 5 are illustrative only, and the invention is not limited to these values.

Although exemplary embodiments of the present invention have been shown and described, it will be apparent to those having ordinary skill in the art that a number of changes, modifications, or alterations to the invention as described herein may be made, none of which depart from the sprit of the present invention. All such changes, modifications, and alterations should therefore be seen as within the scope of the present invention.

What is claimed is:

1. An image forming apparatus comprising:
an automatic document feeder (ADF) for carrying an original document;
a scanner unit having a carriage including a light-source unit for exposing and scanning the original document, and is capable of operating in a first reading mode for reading image information of the original document carried by the ADF with the carriage fixed and a second reading mode for reading the image information of the original document by moving the carriage;
a printer unit for processing the image information read by the scanner unit and forming an image on a paper sheet;
and a controller for controlling the scanning velocity of scanning the original document at the time of reading, and differentiating the reading resolution of the original document in the first reading mode from the resolution of the image formation by the printer unit, so as to make the reading resolution of the original document in the second reading mode substantially equal to the resolution of the image formation by the printer unit.

2. The image forming apparatus according to claim 1,
wherein the controller controls the velocity to carry the paper sheet or the velocity of movement of the carriage for controlling the scanning velocity, and controls the velocity to carry the paper sheet in the first reading mode to be higher than the velocity of movement of the carriage in the second reading mode.

3. The image forming apparatus according to claim 1, wherein the ADF includes a first drive motor for carrying the original document and the scanner unit includes a second drive motor for moving the carriage,
wherein the controller controls the rotation of the first drive motor and the second drive motor for controlling the scanning velocity, so as to make the number of revolutions of the first drive motor in the first reading mode to be larger than the number of revolutions of the second drive motor in the second reading mode.

4. An image forming apparatus comprising:
an automatic document feeder (ADF) for carrying an original document;
a scanner unit having a carriage including a light-source unit for exposing and scanning the original document, and is capable of operating in a first reading mode for reading image information of the original document carried by the ADF with the carriage fixed and a second reading mode for reading the image information of the original document by moving the carriage;
an image processing unit for processing the image information read by the scanner unit and performing image conversion according to the reading magnification;
a printer unit for processing the image information from the image processing unit and forming an image on a paper sheet; and
a controller for controlling the scanning velocity of the original document by the scanner unit to make the setting the scanning velocity in the first reading mode higher than the scanning velocity in the second reading mode, and controlling the image conversion process in the image processing unit according to the reading magnification to control the output resolution of the printer unit in the fist reading mode and the second reading mode.

5. The image forming apparatus according to claim 4,
wherein the controller controls the scanning velocity of the original document in the scanning unit, and differentiates the reading resolution of the original document in the first reading mode from the resolution of the image formation by the printer unit, so as to make the reading resolution of the original document in the second reading mode substantially equal to the resolution of the image formation by the printer unit; and
wherein the controller controls the image conversion process in the image processing unit according to the reading magnification, and the output resolution of the printer unit is maintained in states set in the fist reading mode and the second reading mode, respectively.

6. The image forming apparatus according to claim 4, wherein the ADF includes a first drive motor for carrying the original document and the scanner unit includes a second drive motor for moving the carriage,
wherein the controller controls the rotation of the first drive motor and the second drive motor for controlling the velocity to carry the paper sheet at the first reading mode to be higher than the velocity of movement of the carriage at the second reading mode.

7. The image forming apparatus according to claim 4,
wherein the controller controls to increase the number of revolutions of the first drive motor step by step with decrease of the reading magnification in the first reading mode.

8. The image forming apparatus according to claim 4,
wherein the controller is able to switch the number of revolutions of the first drive motor in a plurality of levels, and controls to increase the number of revolutions of the first drive motor step by step with decrease of the reading magnification in the first reading mode.

9. The image forming apparatus according to claim 4,
wherein the controller enlarges or contracts the read image information when the reading magnification is enlargement or contraction on the basis of the image information at the time of the equal magnification in the second reading mode.

10. The image forming apparatus according to claim 4,
wherein the controller enlarges or contracts the read image information when the reading magnification is set to enlargement or contraction on the basis of the image information at the time of the equal magnification in the first reading mode.

11. The image forming apparatus according to claim 4,
wherein the controller controls not to perform the image conversion process by the image processing unit when the reading magnification is set to the equal magnification or enlargement, and to perform contraction by the image processing unit when the reading magnification is set to contraction in the first reading mode.

12. The image forming apparatus according to claim 4,
wherein the image processing unit converts the number of lines of the image information read by the scanner unit, converts the single line image information into n-lines when the reading magnification is n times on the basis of the number of lines when the reading magnification is the equal magnification, and converts the n-line image information into a single line when the reading magnification is 1/n times.

13. An image forming methods comprising:
providing an automatic document feeder (ADF) for carrying an original document and a scanner unit having a carriage including a light-source unit for exposing and scanning the original document,
causing the scanner unit to operate in a first reading mode for reading image information of the original document carried by the ADF with the carriage fixed, or in a second reading mode for reading the image information of the original document by moving the carriage;
setting the scanning velocity of the original document by the scanner unit in the first reading mode to be higher than that in the second reading mode;
performing image conversion for the image information read by the scanner unit in the first reading mode or the second reading mode according to the reading magnification; and
processing the image information read by the scanner unit or the image information after having applied with the image conversion by the printer unit, and forming images on a paper sheet at different output resolutions in the first reading mode and the second reading mode.

14. The image forming method according to claim 13,
wherein the reading resolution of the original document by the scanner unit is set to be lower than the resolution of image formation by the printer unit in the first reading mode, and to be substantially the same as the resolution of the image formation by the printer unit in the second reading mode.

15. The image forming method according to claim 13,
wherein the image conversion process is controlled according to the reading magnification, and the output resolution of the printer unit is maintained in states set in the fist reading mode and the second reading mode, respectively.

16. The image forming method according to claim 13,
wherein the velocity to carry the paper sheet in the first reading mode is set to be higher than the velocity of movement of the carriage in the second reading mode.

17. The image forming method according to claim 16,
wherein the velocity to carry the paper sheet is controlled to increase with decrease of the reading magnification in the first reading mode.

18. The image forming apparatus according to claim 16,
wherein the velocity to carry the paper sheet can be switched in a plurality of levels, and the velocity to carry the paper sheet is controlled to increase step by step with decrease of the reading magnification in the first reading mode.

19. The image forming method according to claim 13,
wherein when the reading magnification is set to enlargement or contraction, the read image information is enlarged or contracted on the basis of the image information at the time of the equal magnification in the first and second reading modes.

20. The image forming method according to claim 13,
wherein the image conversion converts the number of lines of the image information read by the scanner unit, converts the single line image information into n-lines when the reading magnification is n times on the basis of the number of lines when the reading magnification is the equal magnification, and converts the n-line image information into a single line when the reading magnification is 1/n times.
